(19) United States
(12) Patent Application Publication
(10) Pub. No.: US 2011/0268553 A1
(43) Pub. Date: Nov. 3, 2011

(54) ANIMAL HAULING DEVICE

(76) Inventor: Paul D. Hershberger, Millersburg, OH (US)

(21) Appl. No.: 13/096,459

(22) Filed: Apr. 28, 2011

Related U.S. Application Data
(60) Provisional application No. 61/329,328, filed on Apr. 29, 2010.

(51) Int. Cl. B65G 7/12; A01M 31/00

(52) U.S. Cl. 414/800; 294/150

(57) ABSTRACT

This invention relates to an animal hunting device which may be adjustably secured and removed to a head of a fallen game animal to facilitate movement of the animal. The device includes a head belt which forms at least one handle and wraps around the animal head, generally between the antlers and ears, to adjustably secure the animal head. The device further includes a muzzle belt which wraps around the animal muzzle, generally around the nose or muzzle of the animal, to adjustably secure the animal muzzle. Secured on the handle is a connector which is slidable about the handle. The connector may be attached to a vehicle to facilitate mechanical transportation of the animal, while the handle facilitates manual transportation of the animal. This invention may also incorporate a strap element or a measurement component.

### CROSS-REFERENCE TO RELATED APPLICATION

This application claims priority from U.S. Provisional Application Ser. No. 61/329,328, filed Apr. 29, 2010, the disclosure of which is incorporated herein by reference.

### BACKGROUND OF THE INVENTION

1. Technical Field This invention relates generally to a hunting device. More particularly, the invention relates to a device for hauling an animal carcass. Specifically, the invention relates to a wild game animal hauling device which is secured about the neck, head, and muzzle of the animal, to facilitate dragging the animal carcass both manually and mechanically.

2. Background Information

The hunting of wild game such as deer occurs primarily in wooded and remote areas. A hunter commonly travels into these areas on foot or a small motorized vehicle such as an all-terrain vehicle (ATV) to hunt wild game. Hunters encounter substantial difficulty in carrying or transporting fallen game from these remote areas. Large animals such as deer may be up to three hundred pounds, and include antlers which further impede transporting the animal. Often times after downing a large game animal, the hunter must transport the animal carcass through densely wooded areas which are often covered with swamp or brush. In such instances, wheeled motorized vehicles are not suitable and manual means must be used. The hunter may drag the animal carcass out of such densely wood areas to an all-terrain vehicle which is located in a clearing or more easily accessible area.

It is well known in the art to drag animal carcasses by their upper bodies through the use of an animal hauling device. However, the prior art devices have a disadvantage of not facilitating manual dragging as well as mechanical dragging in the same device. When a hunter gets the animal carcass to an all-terrain vehicle, the prior art devices must be disassembled or disconnected from the animal carcass, and a different device must be attached to the animal carcass to facilitate motorized dragging. This requires the hunter to pack, store and transport multiple prior art devices, which increases the time and complexity of transporting the animal and adds weight to the hunter's gear.

Therefore, there is need in the art for an animal drag device which allows a hunter to manually transport or drag an animal carcass to a motorized vehicle, and thereafter attach the animal hauling device easily to the all-terrain vehicle without additional mechanical devices. This animal drag device should also incorporate a means for extending the length of the overall animal drag device so that a hunter can customize the dragging to best fit the situation or terrain. The animal drag device should also be attachable to a hunter's safety harness to facilitate hands-free dragging.

Furthermore, hunters typically desire to measure different body components of the animal on-site, to compare antler sizes or overall game sizes, etc. This requires the hunter to carry a tape-measure or other measurement device during hunting. Therefore, there is need in the art for an animal drag device which incorporates a measurement component into the device itself, thus eliminating the need to carry a separate measurement device.

### BRIEF SUMMARY OF THE INVENTION

The present invention is a lightweight hunter's animal drag device capable of being carried in a compact arrangement on a body of a hunter. The present invention provides a handle for manually transporting animal carcasses and other articles through densely wood areas by one or more hunters. The present invention further provides a connector for attaching the animal carcass to an all-terrain vehicle for mechanically transporting animal carcasses and other articles through generally flat or non-wooded areas. As such, the present invention facilitates both manual and mechanical transportation of the animal, without requiring the use of separate devices. The present invention may also include a separate strap element for extending the overall length of the animal drag device or for attachment to a safety harness worn by the hunter. This allows the hunter to customize the dragging to best fit the situation or terrain. The present invention may also incorporate a measurement component to facilitate measuring features of the animal carcass on-sight, thus eliminating the need to carry a separate measuring device.

The invention broadly comprises multiple straps which wrap around the head portion and the muzzle portion of the slain animal and extend into two looped carrying handles. The carrying handles are threaded through a non-removable hook device which provides the attachment to an all-terrain vehicle. As the hook device is non-removable from the animal drag apparatus, the hook device cannot be lost, or misplaced, or forgotten. Furthermore, as the hook device is slidable along the carrying handle, it may be moved to expose the carrying handles to the hunter to facilitate manual transportation of the animal.

The invention further comprises an adjustable strap element which includes at least one handle and at least one hook. The strap element allows the hunter to extend the overall length of the invention as desired. The at least one handle of the strap element allows the hunter to pull the animal through use of the hunter's hands. Alternatively, the at least one hook allows the hunter to connect the strap element to a safety harness to pull the animal in an “hands free” orientation.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a right side perspective view of the animal hauling device of the present invention mounted on a deer head;

FIG. 2 is left side perspective view of the animal hauling device;

FIG. 3 is a cross-sectional view of the animal hauling device having the head belt in an unsecured position on the deer head;

FIG. 4 is a cross-sectional view of the animal hauling device having the head belt secured to the deer head;

FIG. 5 is a cross-sectional view of the animal hauling device having the muzzle belt unsecured to the deer muzzle;

FIG. 6 is a cross-sectional view of the animal hauling device having the muzzle belt secured to the deer muzzle;

FIG. 7 is a side perspective view of the animal hauling device attached to the deer, and further attached to an all-terrain vehicle;

FIG. 8 is a side perspective view of the animal hauling device attached to the deer and having first handle pulled by a first hunter, and second handle pulled by a second hunter;

FIG. 9 is a side perspective view of the animal hauling device secured around the ears and head of a non-antlered animal and having the front legs extended through the animal hauling device proximate the muzzle area;

FIG. 10 is a perspective view of a strap element of the present invention;

FIG. 11 is a side perspective view of the first hunter pulling the deer using the strap element, whereby the strap element is disposed around the shoulder and arm of the first hunter; and

FIG. 12 is a side perspective view of the first hunter pulling the deer using the strap element, whereby the strap element is connected to a safety harness disposed on the first hunter.

Similar numbers refer to similar parts throughout the drawings.

### DETAILED DESCRIPTION OF THE INVENTION

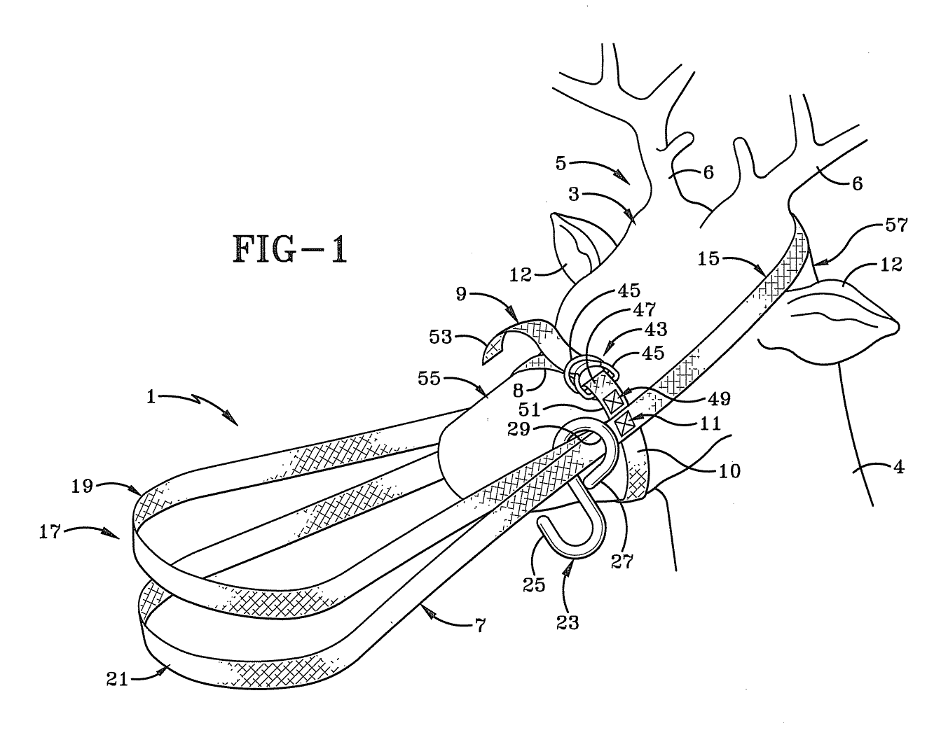

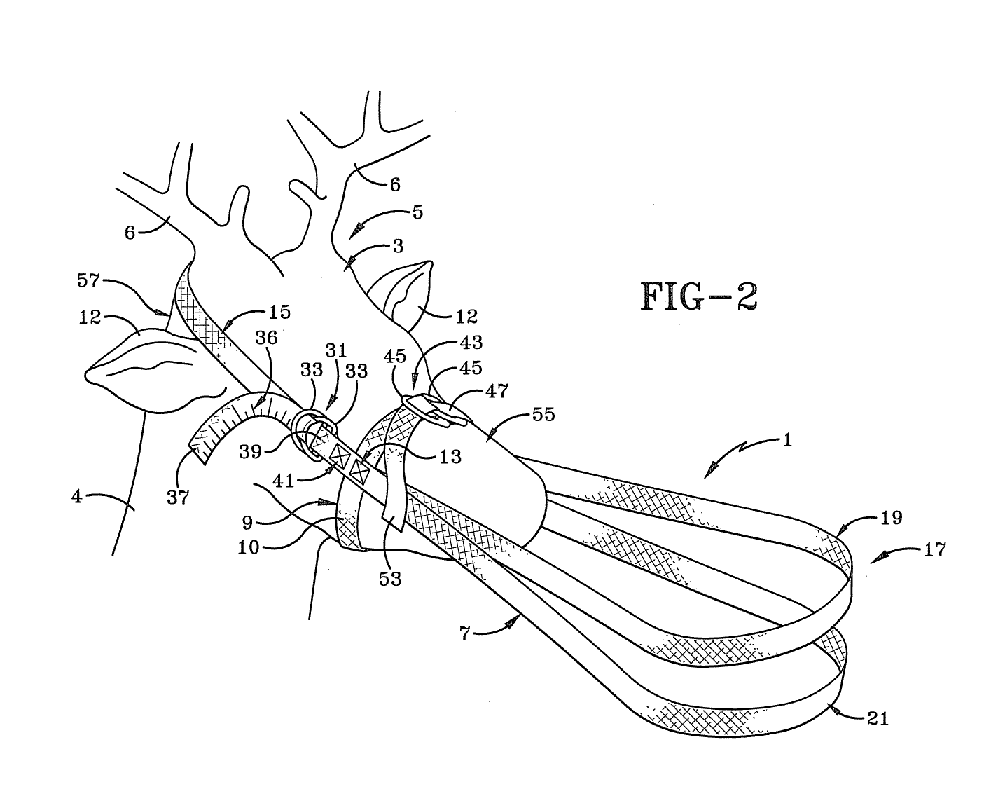

An animal hauling device of the present invention is represented generally at 1, and shown in FIGS. 1-9. As shown particularly in FIGS. 1 and 2, a preferred embodiment of device 1 is shown removably secured to a head 3 extending from a neck 4 of a deer 5 having a pair of antlers 6 and a pair of ears 12. Device 1 is broadly comprised of a head belt 7 secured to a muzzle belt 9, whereby device 1 is adjustably secured to head 3 to facilitate both manual or mechanical transportation of deer 5, at a hunter's discretion.

As shown in FIGS. 1-4, a first end 35 of head belt 7 is secured to an inner surface 8 of muzzle belt 9 at a first joinder area 11. Head belt 7 extends from first joinder area 11 to a second joinder area 13 to form a first handle 19 therebetween. At second joinder area 13, head belt 7 is again secured to inner surface 8 of muzzle belt 9. From second joinder area 13, head belt 7 loops back and is secured to itself at a loop joinder area 41, thereby forming a head loop 39. At loop joinder area 41, head belt 7 extends to second loop joinder area 13 whereby head belt 7 is secured to an outer surface 10 of muzzle belt 9. From second joinder area 13, head belt 7 extends to first joinder area 11 to form a second handle 21 therebetween. At first joinder area 11, head belt 7 is secured to outer surface 10 of muzzle belt 9. From first joinder area 11, head belt 7 extends to allow a second end 37 thereof to engage a pair of D-rings 33 secured to head loop 39, thereby forming an adjustable head buckle 31. In the preferred embodiment, head belt 7 is secured to muzzle belt 9 by stitching. However, the present invention encompasses any means common in the art for securing head belt 7 to muzzle belt 9, including rivets and hot melt adhesives.

As shown in FIG. 2, a measurement component 36 is incorporated into head belt 7 proximate second end 37. Measurement component 36 is shown in the present embodiment as ruler-style indicia disposed on head belt 7, generally corresponding to marks every half inch to indicate length. A user positions measurement component 36 along any desired part of deer 5 or any animal to measure a particular feature. Commonly, the overall length of antlers or length of individual points on deer 5 are measured and compared. In the preferred embodiment, measurement component 36 is shown incorporating ruler-style measurement features, however, any style of lengthwise measurement features may be incorporated into measurement component 36.

Henceforth, the general portion of head belt 7 extending from first joinder area 11 to second end 37 will be referred to as a head portion 15, and the general portion of head belt 7 extending between first joinder area 11 and second joinder area 13 will be referred to as a handle portion 17. In the preferred embodiment, handle portion 17 is comprised of first handle 19 and second handle 21 being in juxtaposition with respect to each other. However, the present invention encompasses only a single handle, or more than one handle.

As shown in FIG. 1, a connector 23 is slidably and non-removably secured to handle portion 17. Connector 23 has a generally S-shape and includes a hook portion 25 extending from a closed portion 27, whereby the closed portion defines an opening 29 therethrough. Handle portion 17 extends through opening 29, whereby connector 23 is slidable along handle portion 17, and prevented from sliding over head portion 15 by muzzle belt 9, secured at first joinder area 11 and second joinder area 13.

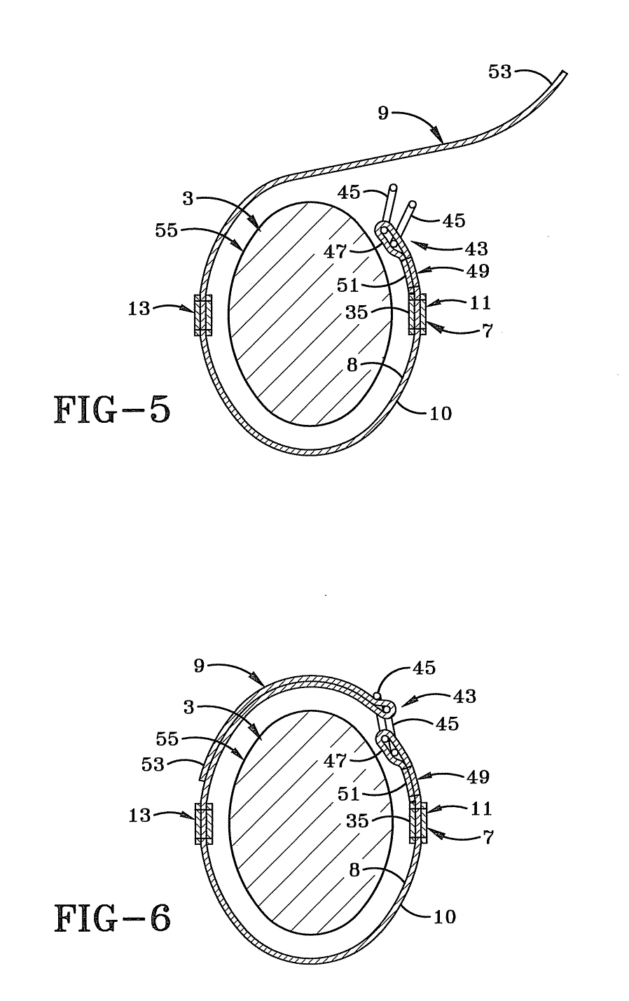

As shown in FIGS. 5 and 6, muzzle belt 9 has a first end 51 and a spaced apart second end 53, and is secured to head belt 7 at first joinder area 11 and second joinder area 13. A muzzle loop 47 is formed by securing a portion of muzzle belt 9 to first end 51 at a muzzle loop joinder area 49. From muzzle loop joinder area 49, muzzle belt 9 is secured to head belt on inner surface 8 and outer surface 10 at first joinder area 11. From first joinder area 11, muzzle belt 9 extends to second joinder area 13, whereby muzzle belt 9 is again secured to head belt 7 on inner surface 8 and outer surface 10. From second joinder area 13, muzzle belt 9 extends to allow second end 53 to engage a pair of D-rings 45 secured to muzzle loop 47, thereby forming an adjustable muzzle buckle 43.

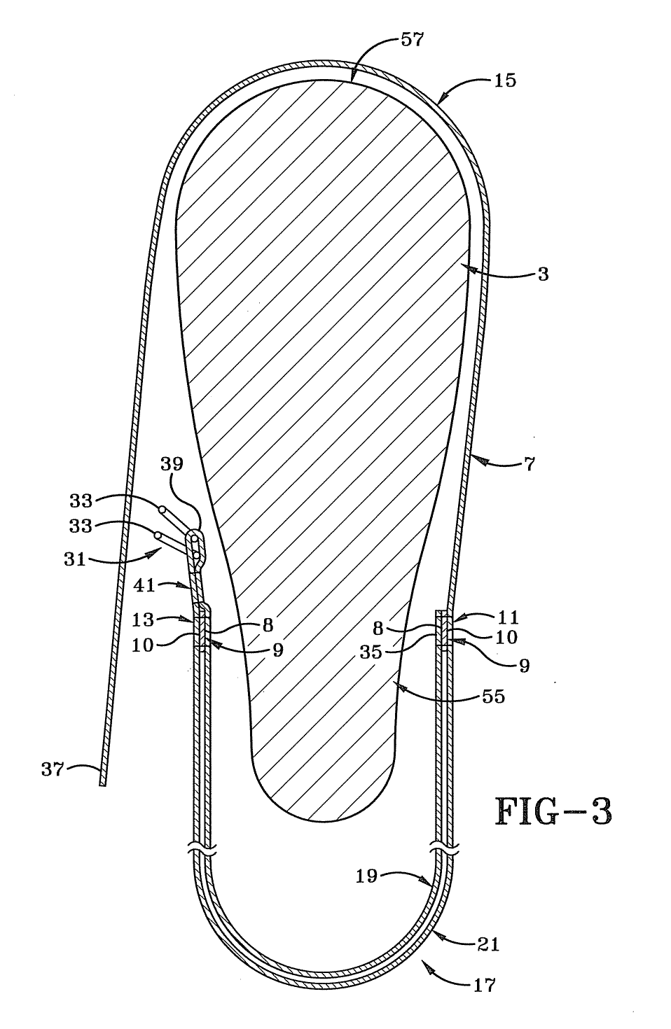

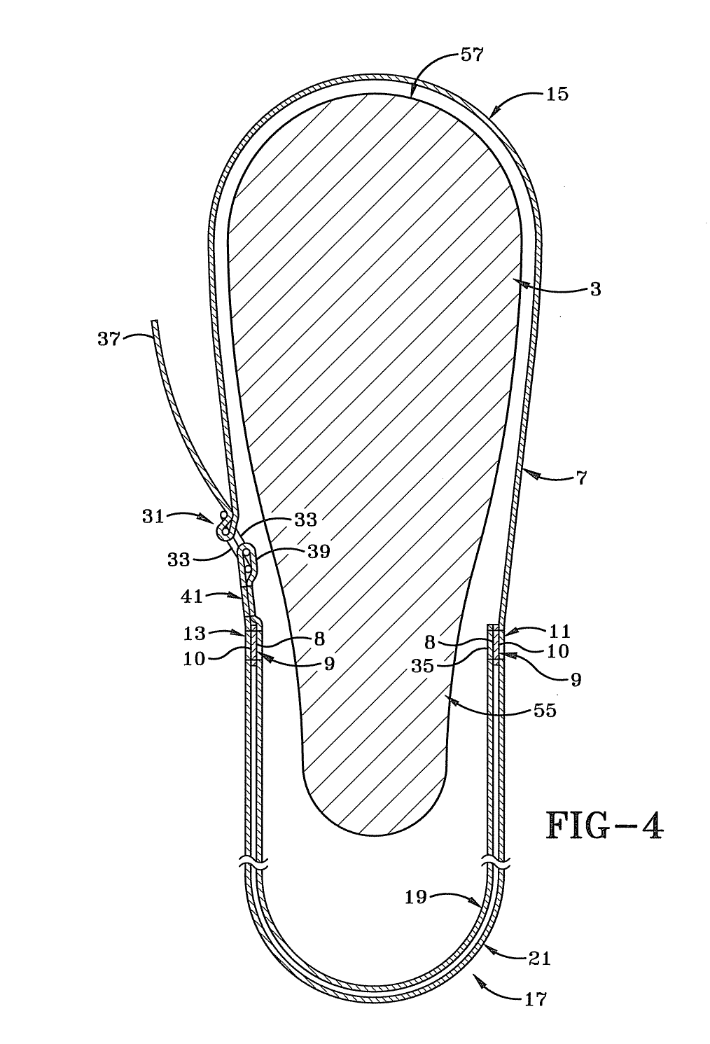

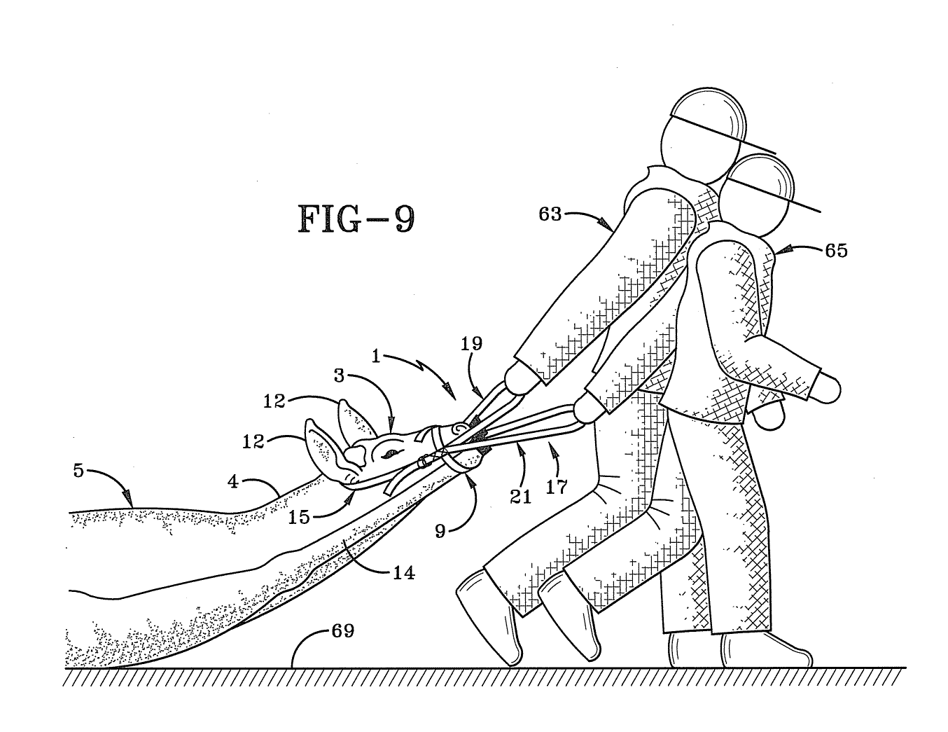

In operation, animal hauling device 1 is used to haul a fallen animal, shown in FIGS. 1-9 as deer 5, from a remote location, which may include generally wooded or difficult terrain. Once the deer has fallen, muzzle belt 9 is wrapped around a muzzle portion 55 of head 3 (FIG. 5), thereafter second end 53 is laced through D-rings 45 of muzzle buckle 43 (FIG. 6). As shown in FIGS. 1 and 6, second end 53 is pulled to tighten muzzle belt 9 around muzzle portion 55 of head 3. Similarly, head belt 7 is wrapped around a back head portion 57 of head 3 (FIG. 3) generally between antlers 6 and ears 12 of an antlered animal, or behind ears 12 of a non-antlered animal (FIG. 9), and thereafter second end 37 is laced through D-rings of head buckle 31 (FIG. 4). As shown in FIGS. 2 and 4, second end 37 is pulled to tighten head belt 7 around back of head portion 57. Head belt 7 and muzzle belt 9 are disposed generally orthogonally around head 3 of deer 5 to attach device 1 securely around head 3. As shown in FIG. 1, when device 1 is secured on head 3, first and second handles 19 and 21, and connector 23 are exposed and readily available to a user. It will be readily understood by those familiar in the art that device 1 is shown spaced apart from muzzle portion 55 and back head portion 57 in FIGS. 3-6 for clarity, and in operation device 1 will be securely abutting muzzle portion 55 and back head portion 57.

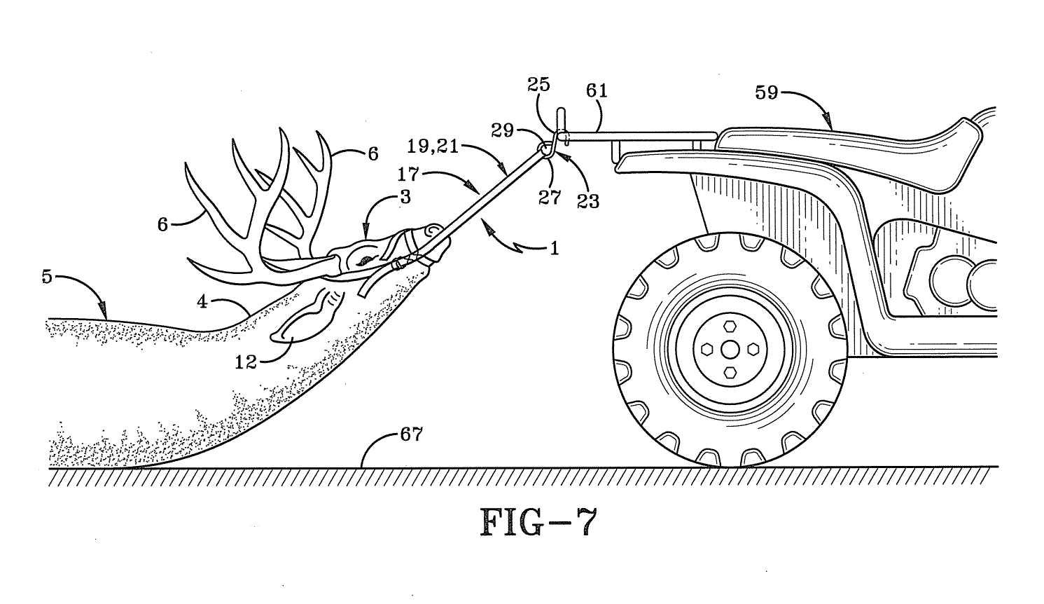

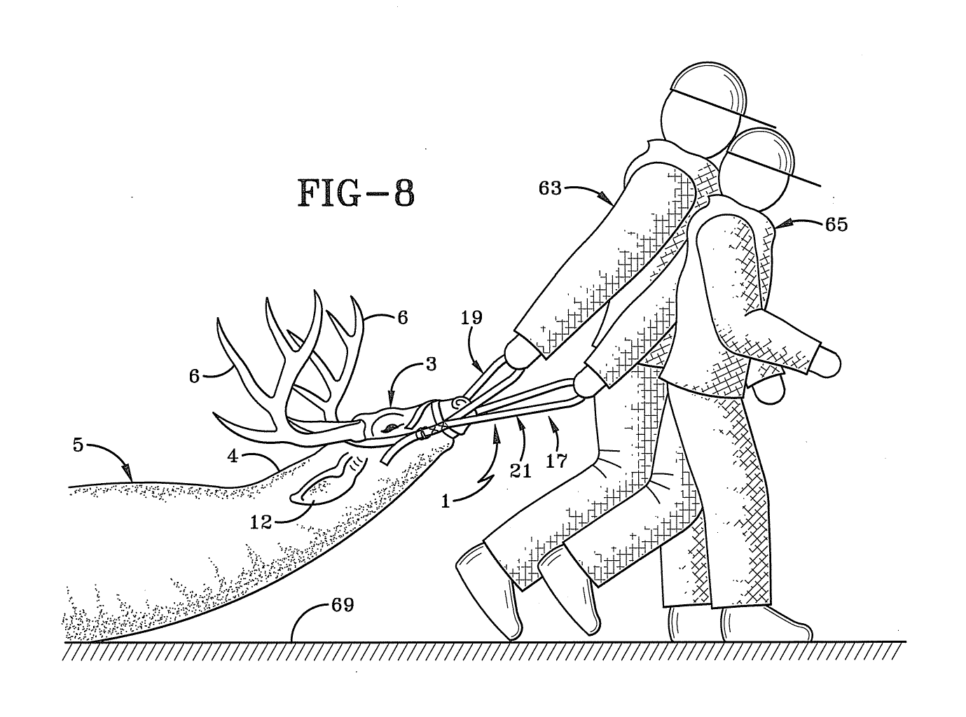

As shown in FIGS. 7 and 8, it is a primary feature of animal hauling device 1 to facilitate both a manual and mechanical transportation of deer 5 at the hunter's discretion. As shown in FIGS. 1 and 7, after animal hauling device 1 is secured on head 3 of deer 5, connector 23 facilitates mechanical transportation of deer 5. Connector 23 is slidably moved along handle portion 17 to extend towards an all terrain vehicle (ATV) 59 having a hitch 61, whereby hook 25 of connector 23 is attached to hitch 61. As shown in FIG. 7, connector 23 facilitates raising antlers 6 off surface 67 when connected to hitch 61, thereby protecting antlers 6 and preserving the appearance. As hunters typically employ such a mechanical device for accessing remote areas, ATV 59 may be proximate deer 5. However, hunters may also be traveling on foot and without immediate access to ATV 59. In such instances, animal hauling device 1 provides handle portion 17 which facilitates manual transportation of deer 5. As shown in FIGS. 1 and 8, connector 23 is slidably moved along handle portion 17 to provide manual access to handle portion 17. Shown in FIGS. 8 and 9, a first hunter 63 thereby grasps and manually pulls first handle 19, and a second hunter 65 grasps and manually pulls second handle 21. First hunter 63 and second hunter 65 may then manually transport deer 5 by pulling first handle 19 and second handle 21.

As shown in FIGS. 7 and 8, deer 5 may be transported along a surface 67 (FIG. 7) or a surface 69 (FIG. 8), wherein surface 67 has different properties than surface 69. A main feature of animal hauling device 1 is thereby providing a hunter discretion over which mode of transportation is preferred, depending on the circumstances. For example, if surface 67 is heavily wooded or rocky terrain where ATV 59 could not travel, first handle 19 and second handle 21 are pulled by the hunter or hunters to facilitate manual transportation of deer 5. Conversely, if surface 69 is generally grassy and smooth, or a large distance from where the hunter desires to transport deer 5, hook 25 of connector 23 may be attached to ATV 59 to facilitate mechanical transportation of deer 5. Both modes of transportation, manual and mechanical, are provided in animal hauling device 1, and may be alternately used as desired by the hunter without disconnecting device 1 from head 3 of deer 5.

As shown in FIG. 9, muzzle loop 47 is sized to allow a pair of front legs 14 of deer 5 to extend through muzzle loop 47. As muzzle loop 47 is tightened around muzzle portion 55, legs 14 are secured thereto. As such, first hunter 63 and second hunter 65 can manually transport deer 5 with legs 14 extending off surface 69, thereby making the overall animal much easier to transport, as legs 14 are not dragging on surface 69 and catching on various branches or other debris on surface 69.

As shown in FIG. 9, animal hauling device 1 further enables the hunter to transport a non-antlered animal. Head loop 39 extends around back head portion 57 and behind ears 12. Ears 12 and the overall shape of head 3 provide a sufficient base for securing head loop 39 firmly around the head 3, and thus allows first hunter 63 and second hunter 65 to manually transport a non-antlered animal as well as an antlered animal, as discussed previously.

Shown particularly in FIGS. 3 and 4, it is another primary feature of the present invention that a single belt, namely head belt 7, forms adjustable head portion 15, first handle 19, second handle 21, head loop 29, and includes second end 37, which extends through an adjustable securing mechanism, namely head buckle 31. Furthermore, a single belt, namely muzzle belt 9, forms muzzle loop 47, and includes second end 53, which extends through an adjustable securing mechanism, namely muzzle buckle 43. Thus, two belts, head belt 7 and muzzle belt 9, form the overall mechanism to secure animal hauling device 1 onto head 3 of deer 5. This represents a significant reduction in materials over the prior art, and significantly reduces production and raw material costs.

Head buckle 31 and muzzle buckle 43 are shown having D-rings 33 and D-rings 45, respectively, as the mechanism for securing second end 37 of head belt 7 and second end 53 of muzzle belt 9, respectively. However, the present invention encompasses any securing mechanism common in the art, including but not limited to a clasp, a plurality of snap fasteners having a press stud, a conventional buckle having a prong extending into holes defined by head belt 7 and muzzle belt 9, and hook and loop.

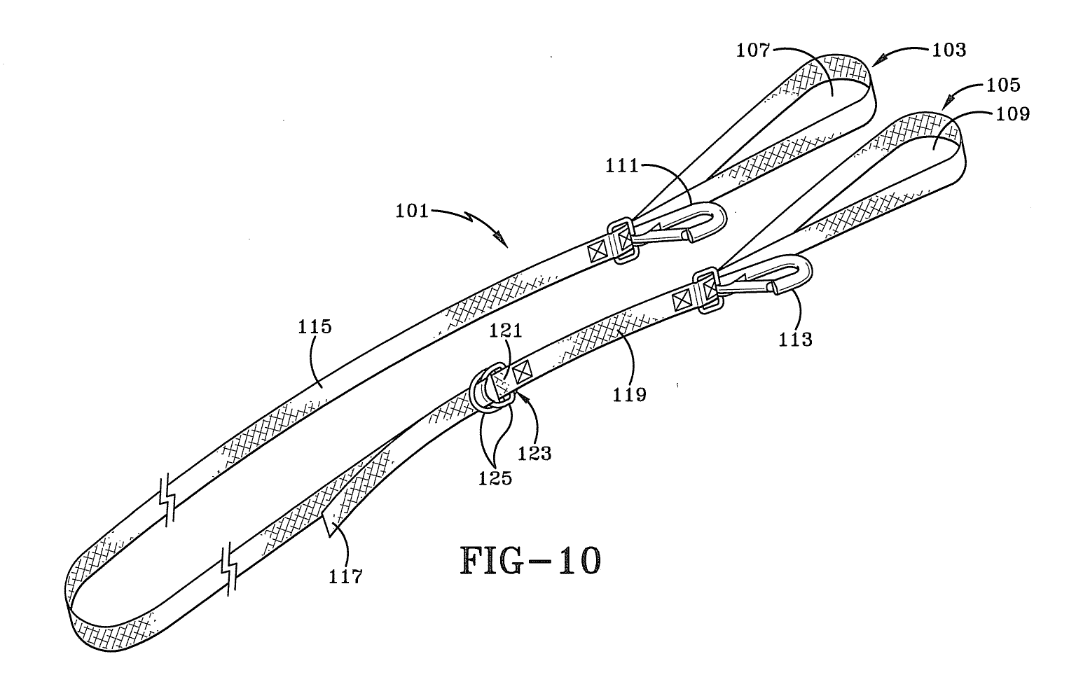

As shown in FIGS. 10-12, a strap element 101 may be used in conjunction with device 1 to facilitate movement of deer 5. As shown in FIG. 10, strap element 101 is comprised primarily of a first portion 102 and a second portion 104 removably and adjustably secured together in an assembled state (FIG. 10). When strap element 101 is in the assembled state, strap element 101 extends from a first end 103 to a second end 105. Strap element 101 includes a first handle 107 disposed on first portion 102 proximate first end 103, and a second handle 109 disposed on second portion 104 proximate second end 105. Strap element 101 further includes a first hook 111 disposed on first portion 102 proximate first handle 107 and a second hook 113 disposed on second portion 104 proximate second handle 109.

First portion 102 includes an elongated strap portion 115 extending from proximate first hook 111 and terminating at a free end 117. Second portion 104 includes a shortened strap portion 119 extending from proximate second hook 113 and terminating at a looped end 121. Looped end 121 forms an opening 123 for securing a pair of D-rings 125 therein. As shown in FIG. 10, free end 117 is adjustably connected with looped end 121 by way of D-rings 125 to configure strap element 101 in the assembled state.

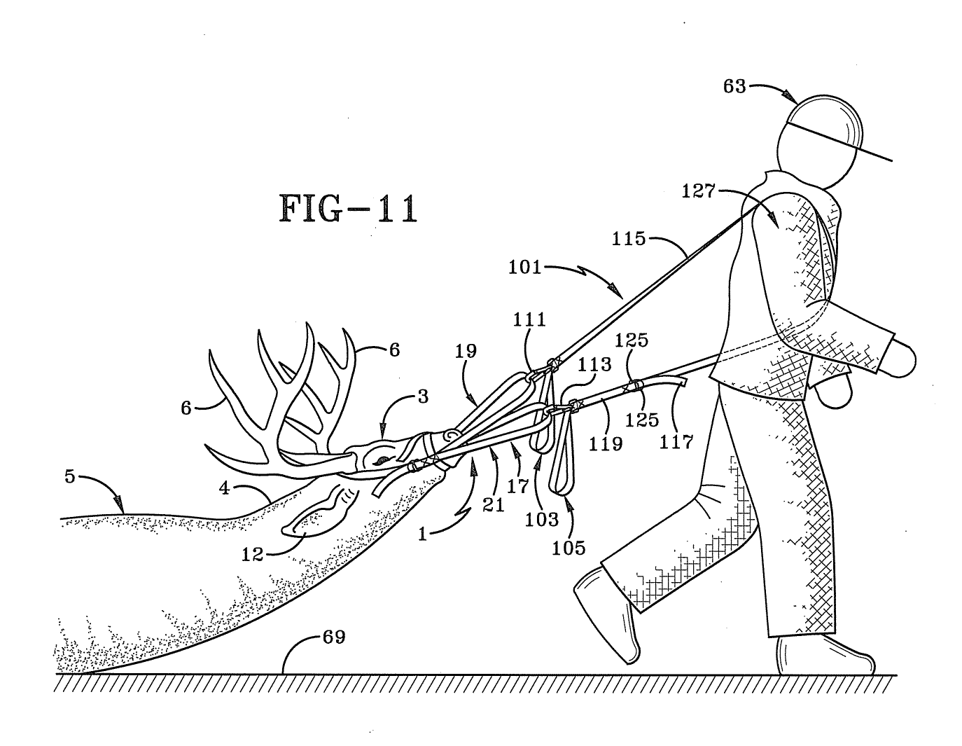

Strap element 101 is used in conjunction with device 1 to facilitate transportation of deer 5. As shown in FIG. 11, one method of using strap element 101 includes securing first hook 111 to first handle 19, second hook 113 to second handle 21, and extending elongated strap portion 115 around a portion 127 of first hunter 63. Portion 127 is shown as an arm/shoulder area in FIG. 11, however, portion 127 may include any convenient area of first hunter 63. D-rings 125 may be used to adjust the overall length of strap element 101 to more easily conform to portion 127 or the user's desired method of use.

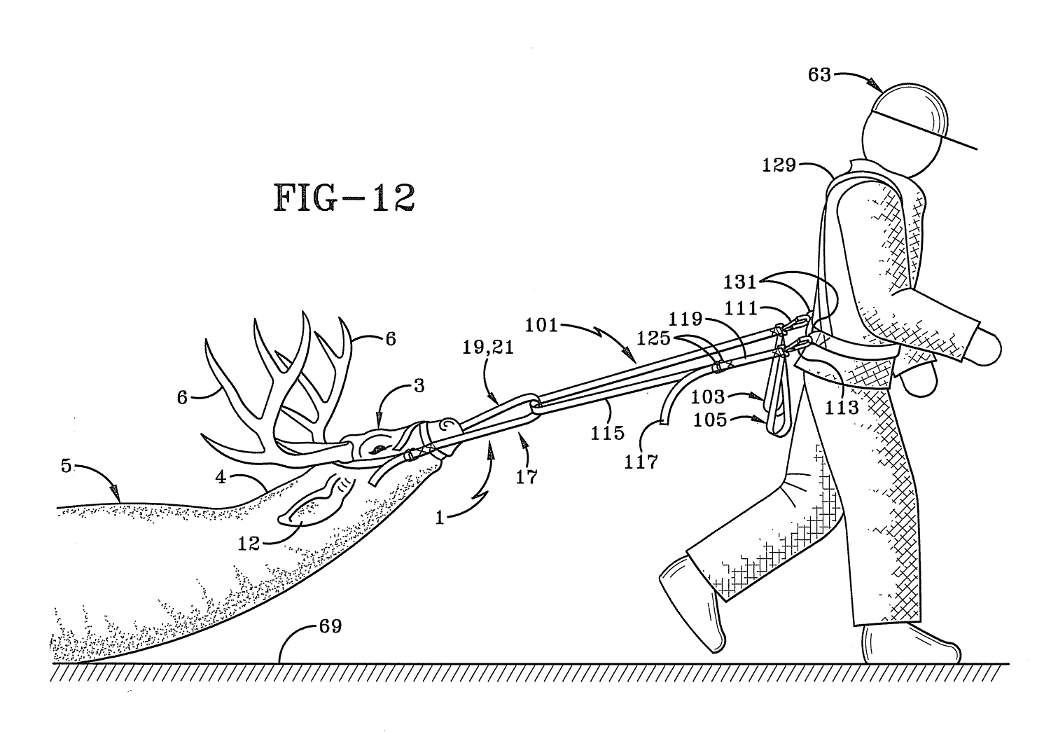

As shown in FIG. 12, elongated strap portion 115 may be extended through first handle 19 and second handle 21 such that first hook 111 and second hook 113 are spaced apart from device 1. In this configuration, first hunter 63 may manually pull first handle 107 and/or second handle 109 to transport deer 5. Alternatively, first hunter 63 may connect first hook 111 and second hook 113 to a pair of loops 131 disposed on a safety harness 129 worn by first hunter 63. First hunter 63 may then simply walk ahead to transport deer 5 through the use of safety harness 129. It is well known in the art that safety harness 129 is typically worn by a deer hunter while the hunter sits off the ground in a tree stand. Inasmuch as first hunter 63 may already be wearing safety harness 129 during the act of hunting deer 5, strap element 101 incorporates a method of transporting deer 5 by utilizing harness 129.

Strap element 101 may also be secured to device 1 by fist end 103 while second end 105 is free to be pulled by hunter 63. First end 103 is secured to device 1 by either by engaging first handle 107 with hook portion 25 of connector 23; or by engaging first hook 111 with either handle 19 or handle 21, or both. Thus, the overall length of device 1 may be dramatically increased by this method of use.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An animal hauling device, comprising:
a head belt having a first end and a spaced apart second end;
a muzzle belt having a first end and a spaced apart second end, an inner surface, and an outer surface, whereby the head belt is secured to the muzzle belt at a first joinder area, and whereby the head belt is secured to the muzzle belt at a spaced apart second joinder area;
a handle portion formed by the head belt, whereby the handle portion extends between the first joinder area and the second joinder area.

2. The animal hauling device of claim 1, wherein the handle portion is comprised of a plurality of handles.

3. The animal hauling device of claim 2, wherein the plurality of handles are oriented in juxtaposition with respect to each other.

4. The animal hauling device of claim 1, further comprising a connector secured on the handle portion and slidable between the first joinder area and the second joinder area thereon.

5. The animal hauling device of claim 4, further comprising a strap element comprising at least one handle and at least one hook, and wherein the overall length of the strap element is adjustable.

6. The animal hauling device of claim 4, wherein the connector is non-removably secured on the handle portion.

7. The animal hauling device of claim 6, further comprising a hook disposed on the connector.

8. The animal hauling device of claim 7, wherein the handle portion is comprised of a plurality of handles, and wherein the plurality of handles are oriented in juxtaposition with respect to each other.

9. The animal hauling device of claim 1, whereby the head belt is secured to the inner surface and the outer surface of the muzzle belt at the first joinder area.

10. The animal hauling device of claim 9, whereby the head belt is secured to the inner surface and the outer surface of the muzzle belt at the second joinder area.

11. The animal hauling device of claim 10, further comprising a connector secured on the handle portion and slidable between the first joinder area and the second joinder area thereon.

12. The animal hauling device of claim 11, wherein the handle portion is comprised of a plurality of handles.

13. The animal hauling device of claim 12, wherein the plurality of handles are oriented in juxtaposition with respect to each other.

14. The animal hauling device of claim 13, further comprising a strap element comprising at least one handle and at least one hook, and wherein the overall length of the strap element is adjustable.

15. The animal hauling device of claim 13, further comprising a measurement component disposed on one of the head belt and muzzle belt.

16. A method of hauling a dead animal comprising the steps of:
forming a first belt into a first loop;
forming the first belt into a plurality of second loops oriented in juxtaposition with one another;
forming a second belt into a third loop;
connecting the first belt to the second belt in at least two joinder areas;
extending the first loop around a head of the animal;
extending the third loop around a muzzle of the animal; and
pulling the plurality of second loops to haul the animal.

17. The method of claim 16, further comprising the step of extending a pair of front legs disposed on the animal through the third loop.

18. The method of claim 16, further comprising the steps of:
securing a connector with a hook portion onto the plurality of second loops; and
pulling the connector to haul the animal.

19. The method of claim 18, further comprising the steps of:
securing a strap element to the plurality of second loops; and
pulling the strap to haul the animal.

20. An animal hauling device comprising:
a one-piece first belt forming a first loop and a pair of second loops, said second loops being in juxtaposition with respect to each other;
a head buckle for adjusting the size of the first loop;
a one-piece second belt forming a third loop, said second belt secured to the first belt in a first joinder area and a spaced apart second joinder area;
a muzzle buckle for adjusting the size of the second loop; and
a connector secured on the pair of second loops and movable between the first joinder area and the second joinder area thereon.

21. The animal hauling device of claim 20, further comprising a strap element comprising at least one handle and at least one hook, and wherein the overall length of the strap element is adjustable.
